(19) United States
(12) Patent Application Publication
(10) Pub. No.: US 2008/0078839 A1
(43) Pub. Date: Apr. 3, 2008

(54) Electro-optical reader with object sensor

(76) Inventor: Edward Barkan, Miller Place, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/528,908

(22) Filed: Sep. 28, 2006

(51) Int. Cl. G06K 7/10

(52) U.S. Cl. 235/470

(57) ABSTRACT

A pulsed light source emits pulsed light at a pulse frequency during an object-sensing mode of a reader for electro-optically reading indicia on objects. A scanner scans the indicia with laser light for reflection therefrom during a scan mode. A light collection system detects the laser light reflected from the indicia and generates an electrical signal indicative of the indicia being read during the scan mode. A controller processes the electrical signal into data corresponding to the indicia being read during the scan mode. The same light collection system detects the pulsed light reflected from the objects and generates a trigger signal indicative of the presence of the objects during the object-sensing mode. The same controller processes the trigger signal to automatically switch from the object-sensing mode to the scan mode.

### BACKGROUND OF THE INVENTION

Various electro-optical readers have previously been developed for reading bar code symbols appearing on a label, or on a surface of a target. The bar code symbol itself is a coded pattern of indicia. Generally, the readers electro-optically transform graphic indicia of the symbols into electrical signals, which are decoded into alphanumeric characters. The resulting characters describe the target and/or some characteristic of the target with which the symbol is associated. Such characters typically comprise input data to a data processing system for applications in point-of-sale processing, inventory control, article tracking and the like.

Moving beam electro-optical readers have been disclosed, for example, in U.S. Pat. No. 4,251,798; No. 4,369,361; No. 4,387,297; No. 4,409,470; No. 4,760,248; and No. 4,896,026, and generally include a light source consisting of a gas laser or semiconductor laser for emitting a laser beam. The laser beam is optically modified, typically by a focusing optical assembly, to form a beam spot having a certain size at a predetermined target location. The laser beam is directed by a scanning component along an outgoing optical path toward a target symbol for reflection therefrom. In response to manual actuation of a physical trigger, the reader operates by repetitively scanning the laser beam in a scan pattern, for example, a line or a series of lines across the target symbol by movement of the scanning component, such as a scan mirror, disposed in the path of the laser beam. The scanning component may sweep the beam spot across the symbol, trace a scan line across and beyond the boundaries of the symbol, and/or scan a predetermined field of view.

Moving beam electro-optical readers also have a light collection system that includes a photodetector and an optical filter which together function to detect laser light reflected or scattered from the symbol. In some systems, the photodetector is positioned in the reader in a return path so that it has a field of view, which extends at least across and slightly beyond the boundaries of the symbol. A portion of the laser beam reflected from the symbol is detected, amplified and converted into an analog electrical signal. An electrical filter rejects electrical noise. A digitizer digitizes the filtered analog signal. The digitized signal from the digitizer is then decoded by a microprocessor, based upon a specific symbology used for the symbol, into a binary data representation of the data encoded in the symbol. The binary data may then be converted into the alphanumeric characters represented by the symbol. The data may be decoded locally or sent to, and decoded in, a remote host for subsequent information retrieval.

Moving beam electro-optical readers have been used for reading one-dimensional symbols each having a row of bars and spaces spaced apart along one direction, and for processing two-dimensional symbols, such as Code 49, as well. Code 49 introduced the concept of vertically stacking a plurality of rows of bar and space patterns in a single symbol. The structure of Code 49 is described in U.S. Pat. No. 4,794,239. Another two-dimensional code structure for increasing the amount of data that can be represented or stored on a given amount of surface area is known as PDF417 and is described in U.S. Pat. No. 5,304,786.

Depending upon the application, such moving beam readers can be configured in various configurations and used in different ways. For example, a gun-shaped housing is typically held in the palm of a human operator's hand during reading in a handheld mode, or optionally supported on a dummy stand or fixture when not held in the operator's hand in a workstation mode. The dummy stand typically serves as a convenient countertop mount or equipment perch to provide ready access of the reader to the operator. As another example, the reader may be configured as a box-shaped housing that is permanently fixed in position, or that temporarily rests on a countertop to read symbols in a workstation mode, and is from time to time lifted off the countertop and aimed at the symbols to read them in a handheld mode. In parcel delivery and tracking applications, some of the components of the reader are mounted in one or more modules and supported on the body, neck, arm, wrist, and/or finger of the operator, with a wired and/or wireless connection between the modules and with a base station.

As advantageous as these types of readers are, experience has shown that they are unsatisfactory in some respects. For example, physical triggers, in some applications, are awkward to actuate and are prone to breakage, especially after repeated, prolonged use. The art has proposed so-called “triggerless” readers that have no trigger to break, but these readers are energized all the time, thereby consuming electrical energy. This is a problem for battery-operated readers, and especially for small form factor readers of the type supported on the operator since a smaller reader has a smaller, lighter battery that has a correspondingly smaller energy capacity.

Many triggerless reader employ an extra infrared (IR) light emitting diode (LED) and an extra complementary IR sensor, both mounted in a front end or nose of the reader. When the nose is aimed at a symbol, light from the IR LED reflects therefrom and is detected by the IR sensor. A drive transistor with a high gain is typically used to drive the IR LED with a large electrical current to emit the IR light therefrom with a great intensity so that the IR sensor can detect the IR light reflected from a symbol that is far away from the nose. IR light is used since it is invisible to the human eye and is also undetectable by the reader's light collection system because the frequency of the IR light is different from the passband frequency of the optical filter employed in the light collection system, thereby avoiding interference between the laser light and the IR light.

Additional object-sensing circuitry is connected to the IR sensor for amplifying and conditioning an output IR signal from the IR sensor. This object-sensing circuitry detects a change in the amplitude of the output IR signal when an object is placed in the field of view of the IR sensor. This amplitude change in the output IR signal is used to initiate scanning and reading of the symbol. However, the drive for the IR LED, the IR sensor, and the additional object-sensing circuitry represent not only an additional expense and increased energy consumption, but also occupy additional space which, in some applications, for example, an operator-supported reader, is in short supply.

### SUMMARY OF THE INVENTION

One feature of this invention resides, briefly stated, in a reader for, and a method of, electro-optically reading indicia on objects, which comprise a pulsed light source, preferably a light emitting diode (LED), for emitting pulsed light at a pulse frequency during an object-sensing mode, and a scanner for scanning the indicia with laser light from a laser for reflection therefrom during a scan mode. A light collection system is operative for detecting the laser light reflected from the indicia and for generating an electrical signal indicative of the indicia being read during the scan mode. A controller is operative for processing the electrical signal into data corresponding to the indicia being read during the scan mode.

In accordance with this invention, the same light collection system is also operative for detecting the pulsed light reflected from the objects and for generating a trigger signal indicative of the presence of the objects during the object-sensing mode, and the same controller is also operative for processing the trigger signal to automatically switch the reader from the object-sensing mode to the scan mode. Thus, this invention eliminates the prior art requirement for using an extra IR sensor and for using additional object-sensing circuitry.

The light collection system preferably includes an optical filter having a passband through which both the laser light and the pulsed light pass. For example, if the laser light has a laser wavelength of around 650 nm, then the optical filter has a passband approximately centered around 650 nm, and the pulsed light also has a wavelength of approximately 650 nm. The light collection system also includes an electrical filter having a passband through which both the electrical and the trigger signals pass. For example, the passband of the electrical filter may be configured to allow signals having frequencies above 100 kHz, thereby allowing indicia to be decoded, and the pulsed light is pulsed at such frequencies so that the electrical signal generated therefrom is not blocked by the electrical filter.

Preferably, the light collection system is operative for generating a return signal having a frequency, and the controller is operative for determining whether the frequency of the return signal lies within a predetermined range of the pulse frequency of the pulsed light for a predetermined time period in order to generate the trigger signal. For example, if the pulse frequency is around 100 kHz, then the predetermined time period can be around 1,000 cycles or so. Also, the light collection system can be designed to generate a return signal having a predetermined phase relationship with a pulse signal that pulses the pulsed light source, in which case, the controller is operative for determining whether the predetermined phase relationship lies within a predetermined range, again for a predetermined time period, in order to generate the trigger signal. In addition, the pulsed light source can be pulsed with a distinct flashing pattern, in which case, the controller is operative for determining whether a return signal has this distinct flashing pattern, in order to generate the trigger signal.

The pulsed light source does not need a high gain drive transistor as in the prior art. The light collection system has a gain sufficient by itself to detect the pulsed light. The pulsed light source may be connected directly to a port of the controller due to the high sensitivity of the light collection system. The pulsed light source is only operative during the object-sensing mode, and the scanner is only operative during the scan mode. The trigger signal automatically switches the reader from the object-sensing mode, also known as the sleep mode, to the scan mode.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic view of a portable electro-optical moving beam reader in accordance with this invention;

FIG. 2A is a perspective view of another embodiment of a portable electro-optical reader operative in a workstation mode in accordance with this invention;

FIG. 2B is a perspective view of the embodiment of FIG. 2A in a hand-held mode in accordance with this invention;

FIG. 3 is a perspective view of an operator-supported reader;

FIG. 4 is a perspective view of another embodiment of a portable electro-optical reader operative in either a hand-held mode, or in the illustrated workstation mode, in accordance with this invention; and

FIG. 5 is a block circuit diagram depicting aspects of the invention.

### DETAILED DESCRIPTION OF THE PREFERRED EMBODIMENTS

Reference numeral 120 in FIG. 1 generally identifies a handheld, retro-collective moving beam reader for electro-optically reading indicia, such as bar code symbol 124, located in a range of working distances therefrom. The reader 120 has a pistol grip handle 121. When the reader is actuated, a laser light beam 123 is directed at the symbol 124. The reader 120 includes a housing 125 in which a laser light source 126, a light detector 127, signal processing circuitry 128, and a battery pack 129 are accommodated. A light-transmissive window 130 at a front of the housing enables the light beam 123 to exit the housing, and allows light 131 scattered off the symbol to enter the housing. A keyboard 132 and a display 133 may advantageously be provided on a top wall of the housing for ready access thereto.

In use, an operator holding the handle 121 aims the housing at the symbol in an object-sensing mode of operation, as detailed below. In a subsequent scan mode of operation, the light source 126 emits the light beam 123, which is optically modified and focused by focusing optics 135 to form a beam spot on the symbol 124. The beam travels to a scan mirror 136 which is repetitively oscillated at a scan rate of at least 20 scans a second by a motor drive 138. The scan mirror 136 reflects the beam incident thereon along an outgoing optical path to the symbol 124 for reflection therefrom and sweeps the beam spot across the symbol in a scan pattern. The scan pattern can be a line extending lengthwise along the symbol along a scan direction, or a series of lines arranged along mutually orthogonal directions, or an omnidirectional pattern, just to name a few possibilities.

The reflected light 131 has a variable intensity over the scan pattern and passes through the window 130 along a return path coincident with the outgoing path onto the scan mirror 136 where it is collected by a light collection system and reflected through an optical filter 122 to the photodetector 127 for conversion to an analog electrical signal. Signal processing circuitry 128 digitizes and decodes the signal under control of a microprocessor 140 to extract the data encoded in the symbol.

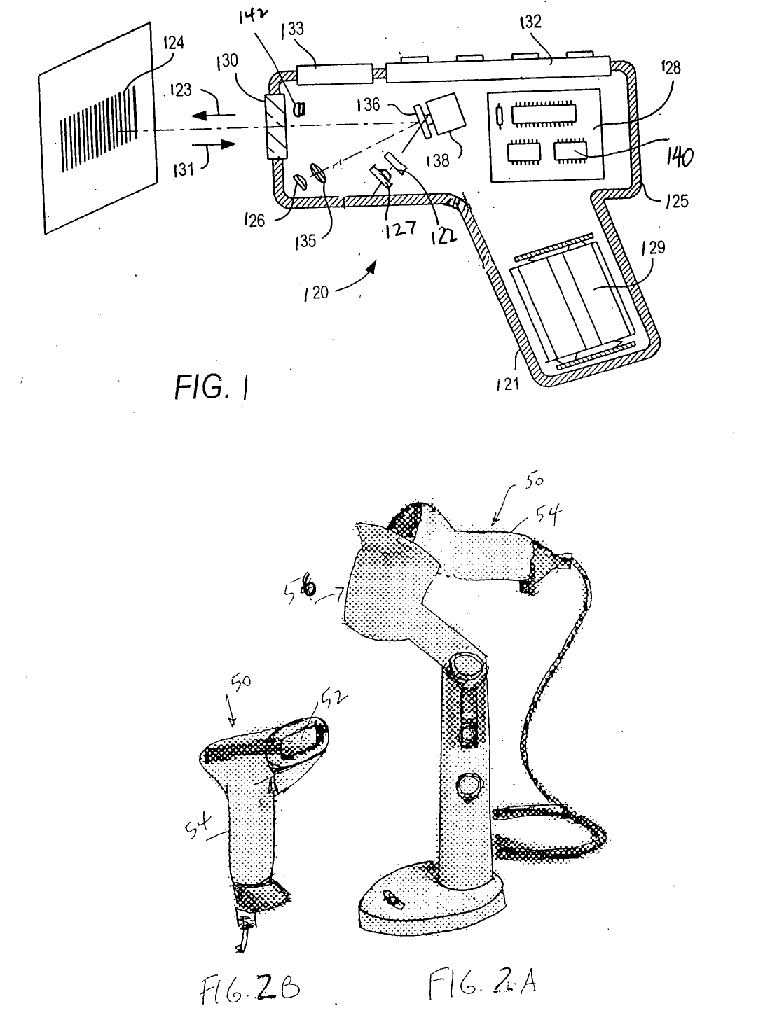

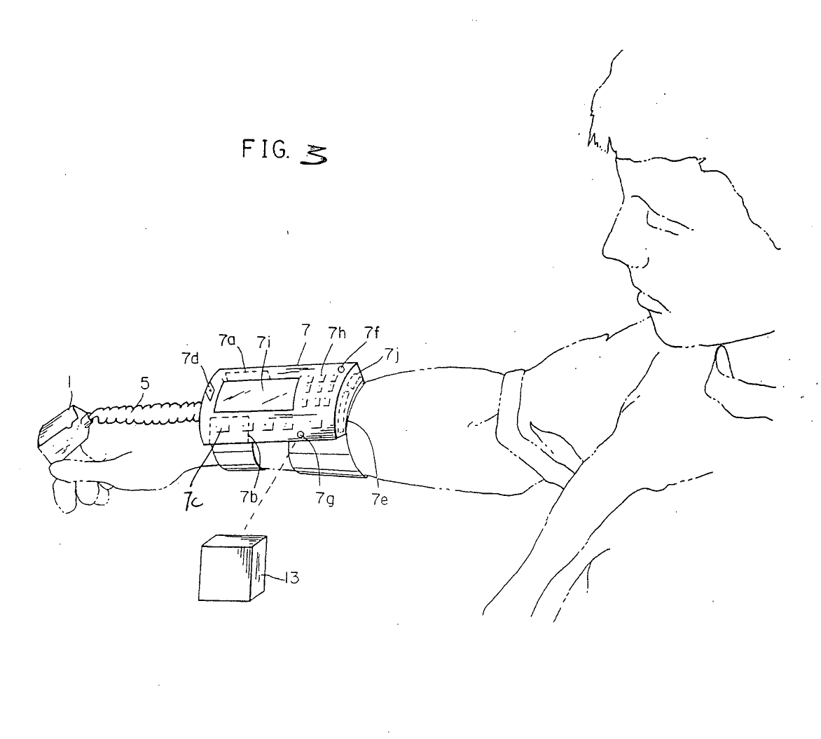

Reference numeral 50 in FIGS. 2A, 2B generally identifies another portable, electro-optical reader having another operational configuration from that of reader 120. Reader 50 has a window 52 mounted on a gun-shaped housing 54 and is supported in a workstation mode (FIG. 2A) by a stand 56 on a countertop. The reader 50 can thus be used as a stationary workstation in which products are slid or swiped underneath the window 52, or can be removed from the stand 56 and held in the operator's hand in a handheld mode (FIG. 2B) and used as a handheld reader.

FIG. 3 depicts an operator-supported reader including a finger-mounted module 1 and a peripheral module 7. One or more of the components depicted in FIG. 1, but especially the laser source 126 and the scan mirror 136, are mounted in the module 1, and the remaining components are mounted in the peripheral module 7. Peripheral module 7 also advantageously includes a battery 7a for supplying power, a receiver 7b for receiving the data from module 1 over a cable 5 connected between the modules, a transmitter 7c for sending data over the cable 5 to the module 1, a cable connector 7d, a microprocessor 7e for controlling operations of the components in module 7, an indicator 7f for indicating a successful reading of a symbol, a wireless transceiver 7g for bidirectional communication with a remote base station or host 13, a keyboard 7h for manual entry of data, a display 71 for displaying information, and a memory 7j for data storage. The cable 5 may be replaced by a wireless link.

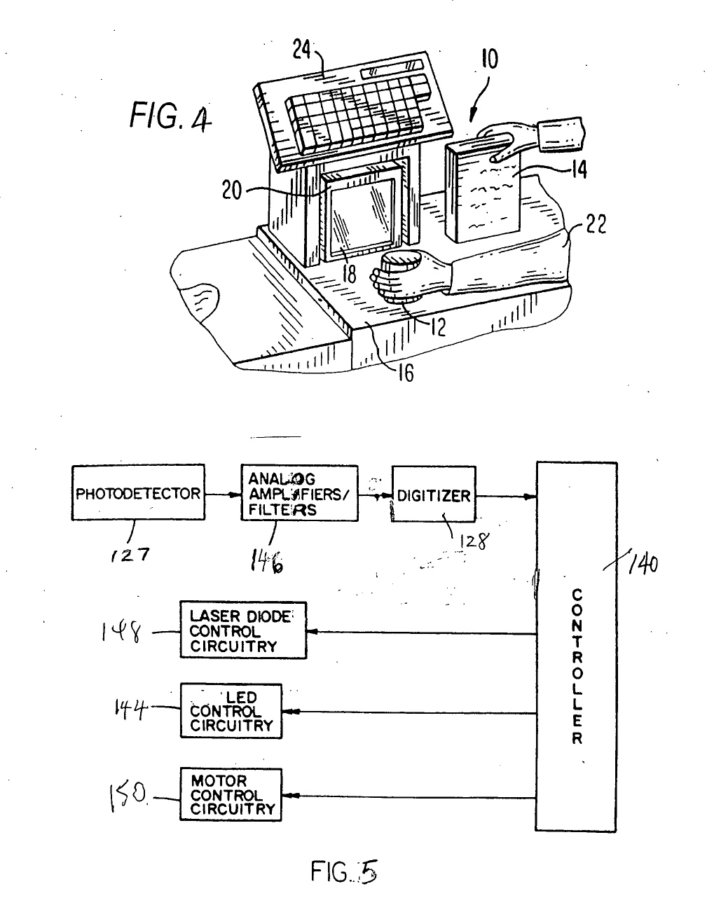

Reference numeral 10 in FIG. 4 generally identifies an electro-optical reader in a workstation mode for processing transactions and mounted on a checkout counter at a retail site at which products, such as a can 12 or a box 14, each bearing a target symbol, are processed for purchase. The counter includes a countertop 16 on which a box-shaped vertical slot reader 20 having a generally vertical window 18 rests. A checkout clerk or operator 22 is located at one side of the countertop, and the reader 20 is located at the opposite side. A cash/credit register 24 is located within easy reach of the operator. In the workstation mode, the operator presents the symbols on the products to the window 18. The reader 20 is portable and lightweight and may be picked up from the countertop 16 by the operator 22 in a handheld mode, and the window 18 may be aimed, in an object-sensing mode, at a symbol preferably on a product too heavy, or too large, or too bulky to be easily positioned on the countertop in front of the window of the reader in the workstation mode.

The moving beam components can be provided in each reader depicted in FIGS. 1, 2A-2B, 3 and 4, as well as other configurations. Thus, as shown in FIG. 1, the moving beam components include a scanner 126, 135, 136, 138 for scanning the indicia 124 with laser light 123 for reflection therefrom during a scan mode. A light collection system 122, 127, 128 is operative for detecting the laser light 131 reflected from the indicia and for generating an electrical signal indicative of the indicia 124 being read during the scan mode. The controller 140 is operative for processing the electrical signal into data corresponding to the indicia being read during the scan mode.

None of the readers described and illustrated herein have a physical trigger to be manually actuated to initiate reading. The readers herein are triggerless, that is, they lack a physical trigger. Instead, triggering is achieved by employing a pulsed light source 142 (see FIG. 1), e.g., an LED, adjacent the window 130 and operative, when energized by LED control circuitry 144 (see FIG. 5) for emitting pulsed light at a pulse frequency during an object-sensing mode. In some applications, the pulsed LED control circuitry 144 can be omitted, because a low magnitude electrical current that is needed to pulse the LED source 142 might be available directly from an output port of the controller 140 that pulses the LED source 142.

In contrast to the prior art, no extra IR sensor is provided to detect the pulsed light reflected from an object, nor is any extra object-sensing circuitry provided. Instead, the same light collection system, including the photodetector 127 and the optical filter 122 that are used for collecting the reflected laser light, is also used for detecting the pulsed light reflected from any objects, and for generating a trigger signal indicative of the presence of any objects during the object-sensing mode. In addition, the same controller that is used for processing the electrical signal indicative of the indicia is also used for processing the trigger signal to automatically switch the reader from the object-sensing mode to the scan mode. Thus, this invention eliminates the prior art requirement for using an extra IR sensor and for using additional object-sensing circuitry.

The light collection system preferably configures the optical filter 122 with a passband through which both the laser light and the pulsed light pass. For example, if the laser light has a laser wavelength of around 650 nm, then the optical filter 122 has a passband approximately centered around 650 nm, and the pulsed light also has a wavelength of approximately 650 nm. The light collection system also includes an electrical filter 146 having a passband through which both the electrical and the trigger signals pass. For example, the passband of the electrical filter 146 may be configured to allow signals having frequencies above 100 kHz, thereby allowing indicia to be decoded, and the pulsed light is pulsed at such frequencies so that the electrical signal generated therefrom are not blocked by the electrical filter 146.

Preferably, the light collection system is operative for generating a return electrical signal having a frequency, and the controller 140 is operative for determining whether the frequency of the return signal lies within a predetermined range of the pulse frequency of the pulsed light for a predetermined time period in order to generate the trigger signal. For example, if the pulse frequency is around 100 kHz, then the predetermined time period can be around 1,000 cycles or so. To minimize false triggering, the predetermined frequency range is made extremely narrow. Also, the light collection system can be designed to generate a return signal having a predetermined phase relationship with a pulse signal that pulses the pulsed light source, in which case, the controller 140 is operative for determining whether the predetermined phase relationship lies within a predetermined range, again for a predetermined time period, in order to generate the trigger signal. In addition, the pulsed light source can be pulsed with a distinct flashing pattern, in which case, the controller is operative for determining whether a return signal has this distinct flashing pattern, in order to generate the trigger signal.

Thus, during the object-sensing mode, when an object is in front of the reader, pulsed light from the pulsing LED source 142 will be collected by the light collection system, amplified, filtered, and digitized, just as if it was a return signal derived from scanning the indicia. The digitizer in the signal processing circuitry 128 digitizes the return signal into square waves that are of the same frequency as the pulse frequency. The controller 140 measures the frequency of the return signal by timing one or more cycles. If the measured frequency is the same or close to the pulse frequency within a predetermined range, this indicates that the return signal is indeed derived from the pulsed light source, and the trigger signal can be generated. The trigger signal might not be an actual electrical signal. Instead, software operating within the controller 140 determines that the return signal is derived from the pulsed light source, and responsively switches the reader from the object-sensing mode to the scan mode.

The pulsed light source 142 does not need a drive transistor as in the prior art. The light collection system is highly sensitive and has a gain sufficient by itself to detect the pulsed light, even if reflected from a far-away object. Indeed, in most applications, the gain may be higher than necessary in the object-sensing mode, in which case, provision must be made to reduce the gain of the light collection system in the object-sensing mode. This can be accomplished by using analog switches under the control of the controller 140. If the light collection system has an automatic gain control circuit, then it may be advantageous to shut it off in the object-sensing mode. The pulsed light source is only operative during the object-sensing mode, and the scanner is only operative during the scan mode. The trigger signal automatically switches the reader from the object-sensing mode, also known as the sleep mode, to the scan mode.

When the reader has finished reading, either because it has successfully decoded the indicia or because a predetermined time period without a successful decode has elapsed, then the laser source 126 and the motor drive 138 are turned off by the controller 140, and the pulsed LED source 142 begins to pulse again. To avoid reading the same indicia twice, the controller is programmed to require the that an object goes away and then comes back before generating another trigger signal.

Hence, one feature of this invention is that the reader has no physical trigger subject to breakage as in the prior art. Also, despite the lack of a physical trigger, the laser source 126 and/or the motor drive 138 are not energized all the time, but are only energized via their control circuits 148, 150 when the trigger signal is generated by the controller 140. This saves electrical energy and increases the lifetime of the on-board battery 129 to power the reader.

It will be understood that each of the elements described above, or two or more together, also may find a useful application in other types of constructions differing from the types described above. For example, the reader need not necessarily be triggerless. In the configuration of FIG. 2A, 2B the reader 50 could be equipped with a physical trigger which is useful in the handheld mode of FIG. 2B. However, in the workstation mode of FIG. 2B, the trigger could be disabled, for example, by being covered by the stand, in which case, the object-sensing mode of this invention would be useful.

While the invention has been illustrated and described as embodied in an object sensor in an electro-optical reader and method, it is not intended to be limited to the details shown, since various modifications and structural changes may be made without departing in any way from the spirit of the present invention. For example, both retrocollective and non-retrocollective readers can be employed. In a non-retrocollective reader, the photodetector 127 and the filter 122 do not face the scan mirror 136, but instead, either directly or indirectly via a stationary fold mirror, face the window 130. In a retrocollective reader of the type shown in FIG. 1, it is especially desirable for the scan mirror 136 to be held stationary in a central position during the object-sensing mode.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims:

1. A reader for electro-optically reading indicia on objects, comprising:
a) a pulsed light source for emitting pulsed light at a pulse frequency during an object-sensing mode;
b) a scanner for scanning the indicia with laser light for reflection therefrom during a scan mode;
c) a light collection system for detecting the laser light reflected from the indicia and for generating an electrical signal indicative of the indicia being read during the scan mode, the same light collection system being also operative for detecting the pulsed light reflected from the objects and for generating a trigger signal indicative of presence of the objects during the object-sensing mode; and
d) a controller for processing the trigger signal to automatically switch from the object-sensing mode to the scan mode, the same controller also being operative for processing the electrical signal into data corresponding to the indicia being read during the scan mode.

2. The reader of claim 1, wherein the light collection system includes an optical filter having a passband through which both the laser light and the pulsed light pass.

3. The reader of claim 1, wherein the light collection system includes an electrical filter having a passband through which both the electrical and the trigger signals pass.

4. The reader of claim 1, wherein the light collection system is operative for generating a return signal having a frequency, and wherein the controller is operative for determining whether the frequency of the return signal lies within a predetermined range of the pulse frequency of the pulsed light for a predetermined time period in order to generate the trigger signal.

5. The reader of claim 1, wherein the light collection system is operative for generating a return signal having a predetermined phase relationship with a pulse signal that pulses the pulsed light source, and wherein the controller is operative for determining whether the predetermined phase relationship lies within a predetermined range for a predetermined time period in order to generate the trigger signal.

6. The reader of claim 1, wherein the light collection system is operative for generating a return signal having a pattern of pulses, and wherein the controller is operative for determining whether the pattern of pulses corresponds to a predetermined pattern in order to generate the trigger signal.

7. The reader of claim 1, wherein the light collection system has a gain sufficient by itself to detect the pulsed light.

8. The reader of claim 1, wherein the pulsed light source is only operative during the object-sensing mode, and wherein the scanner is only operative during the scan mode.

9. The reader of claim 1, and a housing for supporting the pulsed light source, the scanner, the light collection system and the controller, the housing having no physical trigger.

10. The reader of claim 9, and a battery in the housing for supplying electrical power to the pulsed light source, the scanner, the light collection system and the controller.

11. A reader for electro-optically reading indicia on objects, comprising:
a) means for emitting pulsed light at a pulse frequency during an object-sensing mode;
b) means for scanning the indicia with laser light for reflection therefrom during a scan mode;
c) means for detecting the laser light reflected from the indicia and for generating an electrical signal indicative of the indicia being read during the scan mode, the same detecting means being also operative for detecting the pulsed light reflected from the objects and for generating a trigger signal indicative of presence of the objects during the object-sensing mode; and
d) means for processing the trigger signal to automatically switch from the object-sensing mode to the scan mode, the same processing means also being operative for processing the electrical signal into data corresponding to the indicia being read during the scan mode.

12. A method of electro-optically reading indicia on objects, comprising the steps of:
a) emitting pulsed light at a pulse frequency during an object-sensing mode;
b) scanning the indicia with laser light for reflection therefrom during a scan mode;
c) detecting the laser light reflected from the indicia with a light collection system and generating an electrical signal indicative of the indicia being read during the scan mode, the same light collection system being also used for detecting the pulsed light reflected from the objects and for generating a trigger signal indicative of presence of the objects during the object-sensing mode; and
d) processing the trigger signal to automatically switch from the object-sensing mode to the scan mode with a controller, the same controller also being used for processing the electrical signal into data corresponding to the indicia being read during the scan mode.

13. The method of claim 12, and optically filtering the light collection system with a passband through which both the laser light and the pulsed light pass.

14. The method of claim 12, and electrically filtering the light collection system with a passband through which both the electrical and the trigger signals pass.

15. The method of claim 12, and generating a return signal having a frequency, and determining whether the frequency of the return signal lies within a predetermined range of the pulse frequency of the pulsed light for a predetermined time period in order to generate the trigger signal.

16. The method of claim 12, and generating a return signal having a predetermined phase relationship with a pulse signal of the pulsed light, and determining whether the predetermined phase relationship lies within a predetermined range for a predetermined time period in order to generate the trigger signal.

17. The method of claim 12, and generating a return signal having a pattern of pulses, and determining whether the pattern of pulses corresponds to a predetermined pattern in order to generate the trigger signal.

18. The method of claim 12, and providing sufficient gain for the light collection system to detect the pulsed light.

19. The method of claim 12, wherein the step of emitting the pulsed light is only performed during the object-sensing mode, and wherein the step of scanning with the laser light is only performed during the scan mode.

20. The method of claim 12, and the step of performing all the steps within a housing having no physical trigger.

21. The method of claim 19, and the step of supplying electrical power on-board the housing to enable the emitting, scanning, detecting and processing steps to be performed.

22. The method of claim 12, and the step of configuring the pulsed light and the laser light to have wavelengths in a same range of wavelengths.
